(19) United States
(12) Patent Application Publication
(10) Pub. No.: US 2023/0237198 A1
(43) Pub. Date: Jul. 27, 2023

(54) SECURE DATA PROFILE SYSTEM WITH IMPROVED DATA SHARING

(71) Applicant: Bank of America Corporation, Charlotte, NC (US)

(72) Inventors: Ganesh Bonda, Weddington, NC (US); Adithya Gadwale, Falls Church, VA (US); Jayachandra Varma, Irving, TX (US)

(21) Appl. No.: 17/582,470

(22) Filed: Jan. 24, 2022

(51) Int. Cl. G06F 3/06; G06F 21/64

(52) U.S. Cl. CPC G06F 3/0622; G06F 21/64; G06F 3/0647; G06F 3/0683

(57) ABSTRACT

An entity data record includes, for each of a plurality of entities, a plurality of attribute data entries. Each attribute data entry indicates a characteristic of the entity. For each entity of the plurality of entities, an authentication score is determined indicating an extent to which the characteristics indicated by the attribute data entries for the entity are authenticated. The authentication score is stored in memory for each entity in the entity data record. A device provides a request for information about a first entity of the plurality of entities. After receiving the request, one or more attribute entries associated with the first entity and a first authentication score of the first entity are provided to the device.

### TECHNICAL FIELD

The present disclosure relates generally to technologies for data management and security. More particularly, in certain embodiments, the present disclosure is related to a secure data profile system with improved data sharing.

### BACKGROUND

Information associated with a given entity may be stored in a number of different data systems in a wide variety of digital forms. For example, information associated with a given entity or individual may be distributed amongst a number of separate data sources or repositories, for example, on different network servers or other data storage systems.

### SUMMARY

This disclosure recognizes a need for more efficient, reliable, and secure tools for collecting information from a number of data sources, authenticating the information, and providing the information in a secure and user-friendly manner. For example, when information needs to be authenticated for a given entity, previous tools are often inefficient, resulting in the waste of computing resources. For example, network communications between a data review system and a large number of data storage systems may be needed to collect and authenticate information. In these approaches, superfluous data might be collected and/or the same data may be repeatedly collected, resulting in waste of network communication (e.g., network bandwidth) and data storage (e.g., memory) resources. Furthermore, previous technology may require the same or similar information to be processed repeatedly for the same entity when each new authentication task is needed, resulting in a significant waste of processing resources.

Certain embodiments of this disclosure may be integrated into the practical application of a data profile and security system that provides improvements to technology. The data profile and security system facilitates not only the efficient transformation of entity information from a range of data sources into a specially configured entity record but also the secure and reliable provisioning of the data record to requesting parties. For example, the disclosed system and associated devices and methods provide several technical improvements, which include: (1) the ability to unify data from a range of different data sources, as part of a entity record, which may be a stored as a graph database; (2) the ability to efficiently and reliably authenticate information in the entity record; (3) the ability to efficiently and securely provide information from the entity record using a blockchain; and (4) the ability to provide predetermined entity scores without waste of network communication and processing resources by each requesting device to obtain individual entries of entity data and independently determine entity scores on a case-by-case basis. Through these and other technical improvements, the disclosed system and associated devices and methods provide more reliable and secure entity data that is also accessible in a more user-friendly and efficient manner. Also through these technical improvements, this disclosure may improve the function of computer systems used for data security, data management, and data sharing by improving, for example, the security, efficiency, and ease-of-use of such computer systems. Certain embodiments of this disclosure may include some, all, or none of these advantages. These advantages and other features will be more clearly understood from the following detailed description taken in conjunction with the accompanying drawings and claims.

In an embodiment, a system includes a first device with a first memory operable to store an entity data record with, for each of a plurality of entities, a plurality of attribute data entries. Each attribute data entry indicates a characteristic of the entity. A first processor is communicatively coupled to the first memory and determines, for each entity of the plurality of entities, an authentication score indicating an extent to which the characteristics indicated by the attribute data entries for the entity are authenticated. The authentication score is stored in the memory for each entity in the entity data record. A second processor of a second device provides a request for information about a first entity of the plurality of entities. The first processor receives the request for information about the first entity of the plurality of entities. After receiving the request, one or more attribute entries associated with the first entity and a first authentication score of the first entity are provided to the second device.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of an example data profile and security system;

FIG. 2A is a diagram illustrating an example entity data record of the system of FIG. 1 stored as a blockchain;

FIG. 2B is a diagram illustrating an example entity data record stored as a graph database in the blockchain of FIG. 2A;

FIG. 3 is a flow diagram illustrating example operations of the entity record system of the system of FIG. 1; and

FIG. 4 is a flowchart illustrating an example method of operating the system of FIG. 1.

### DETAILED DESCRIPTION

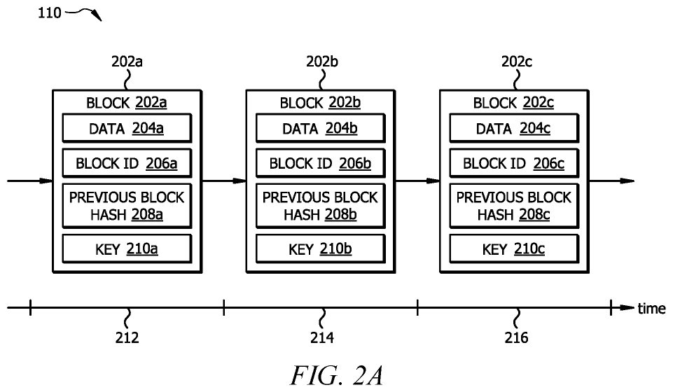

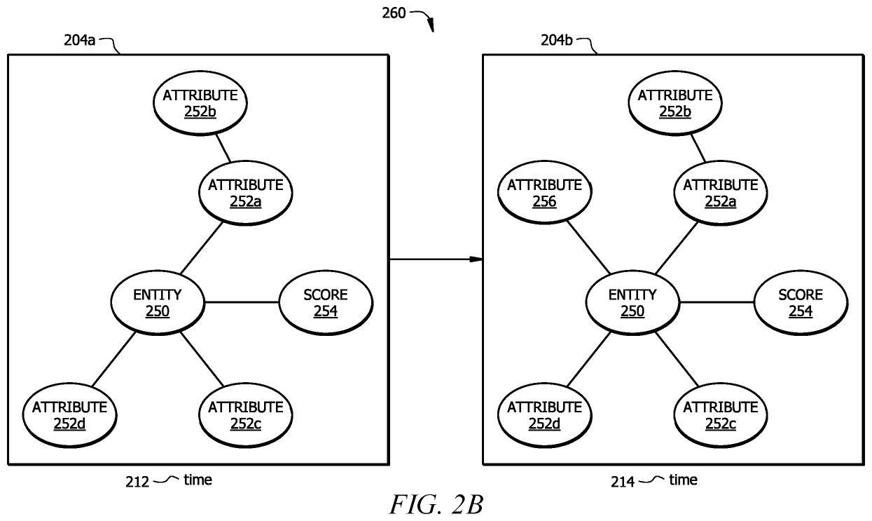

This disclosure provides solutions to the aforementioned and other problems of previous technology by providing an improved data profile and security system that efficiently collects and clusters entity information from a number of data sources and provides this data to requesting parties in a secure, efficient, and user-friendly manner. For example, in some embodiments, an entity data record is maintained as a graph database that is stored within a blockchain. The use of a graph database (see, e.g., FIG. 2B), facilitates user-friendly review of entity information and allows a range of information types to be linked or associated with each other. Meanwhile, the use of a blockchain (see, e.g., FIG. 2A) helps ensure that the entity data is secure, while also facilitating efficient review of how the data is changed and used over time (e.g., by reviewing changes to the blockchain over time).

### Example Data Profile and Security System

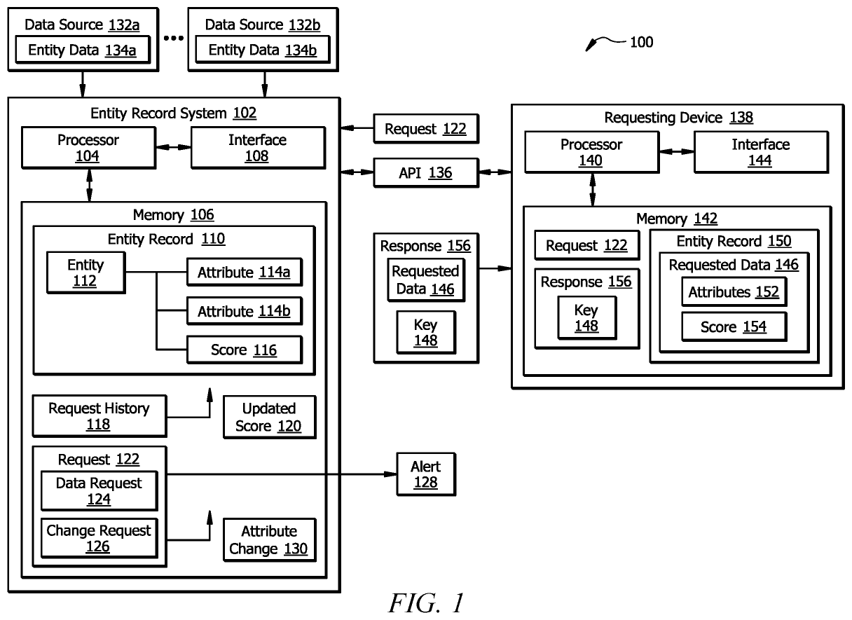

FIG. 1 illustrates an example data profile and security system 100. The system 100 includes an entity record system 102, one or more data sources 132a,b, and a requesting device 138. System 100 generally facilitates improved and more secure access to information about entities 112, as described in greater detail below. In brief, the entity record system generates and stores, in memory 106, an entity data record 110 that includes information about a number of entities 112. The entity data record 110 may be made securely accessible to requesting devices 138, for example, by providing a portion of the information stored in the entity data record 110 and/or providing a key 148 that allows access to requested data 146. The entity record system 102 may further track usage of the entity data record 110 and/or changes to the entity data record 110 in order to efficiently and reliably update the stored information and/or send an alert 128 for review by an appropriate party.

The entity record system 102 is any device or collection of devices (e.g., implemented as physical and/or distributed device network or server) that stores the entity data record 110 and provides controlled access to the entity data record 110. The entity record system 102 receives entity data 134a,b from one or more data sources 132a,b. For example, entity data 134a may be received from a first data source 132a and different (e.g., but potentially complementary) entity data 134b may be received from data source 132b. The first entity data 134a may include or otherwise indicate a first attribute 114a or characteristic of an entity 112. Entities 112 may be, for example, companies, individuals, organizations, groups within an organization, or the like. Meanwhile, the second entity data 134b may include or otherwise indicate a second attribute 114b or characteristic of the entity 112. Attributes 114a,b may include, for example, names, addresses, locations, alternate names, contact information, event dates (e.g., date of birth of individual, date of incorporation or establishment of an organization, etc.), and the like. The different entity data 134a,b may be in different formats. For example, entity data 134a may be a spreadsheet with entries indicating one or more attributes 114a,b of the entity 112, and entity data 134b may be a scanned image of a document associated with an entity 112.

After receiving entity data 134a,b, the entity record system 102 extract attributes 114a,b. For example, certain attributes 114a,b may be extracted from entries of a spreadsheet. In some cases, natural language processing may be used to detect attributes 114a,b within entity data 134a,b, such as documents. Other attributes 114a,b may be determined by manual review of entity data 134a,b that cannot be processed automatically. The entity record system 102 stores the extracted attributes 114a,b for each entity 112 that is monitored by the entity record system 102.

In some embodiments, the entity record system 102 also determines an authentication score 116 for each entity 112 and includes the authentication scores 116 in the entity data record 110. An authentication score 116 may indicate an extent to which an entity 112 is trusted or that the attributes 114a,b are believed to be accurate for the entity 112 (e.g., the extent to which the attributes 114a,b for a given entity 112 can be authenticated). In some cases, the authentication score 116 may provide a metric for verifying the authenticity of an entity's identity and/or verifying other information about an entity 112 (e.g., whether certain accounts are really associated with an entity 112, whether certain addresses or other locations are associated with the entity 112, etc.).

The entity data record system 102 may be communicatively coupled to an application programming interface (API) 136 to allow access to all or portion of the information in the entity data record 110 to requesting devices 138. API 136 may facilitate user-initiated and/or automated queries of information stored in the entity data record 110. A request 122 for information stored in the entity data record 110 (e.g., a data request 124) or to change information in the entity data record 110 (e.g., a change request 126) may be routed through the API 136.

When the request 122 is received, the entity record system 102 determines an appropriate action and implements the action. For instance, after receiving a data request 124 asking for attributes 114a,b and/or an authentication score 116 of an entity 112, the entity record system 102 may provide a response 156 that includes all or a portion of the requested data 146 (e.g., the requested attributes 152 and/or the requested authentication score 154) and/or a key 148 that allows the requesting device 138 to access the requested data 146. For example, as described in greater detail below and with respect to FIGS. 2A and 2B, the entity data record 110 may be stored as a blockchain. In such cases, a requesting device 138 may store a local copy (or portion) of the blockchain as entity record 150. The key 148 may allow the requesting device 138 to access (e.g., read, decrypt, etc.) the requested data 146 from within the entity record 150. Other information in the entity record 150 would generally not be accessible to the requesting device (e.g., without permission from the entity record system 102, such as in the form of key 148). In some cases, such as if greater than a threshold number of data requests 124 are received in a given period of time, an alert 128 may be sent (e.g., to the requesting device 138 or another device, such as an administrator device) to review the possible cause of the repeated requests 124.

If a change request 126 is received asking to change a data entry in the entity data record 110 for an attribute 114a,b (e.g., to change a name, address, location, date, etc. for a given entity 112), the entity record system 110 determines whether this change request 126 is valid or authenticated before making the attribute change 130. For example, the entity record system 102 may determine whether the requesting device 138 that sent the change request 126 is a trusted device (e.g., a device 138 operated or associated with a trusted party). If the requesting device 138 is trusted, the attribute change 130 may be made to the attribute(s) 114a,b in the entity data record 110.

As described briefly above, in some cases, the entity data record 110 is stored in a blockchain, such that all or a portion of the entity data record 110 is distributed amongst multiple devices. In some cases, the entity record system 102 may be a distributed system and store the blockchain entity data record 110. In other cases, requesting devices 138 may store all or a portion of the blockchain entity data record 110. This scenario is illustrated in FIG. 1 through the entity record 150, which may include all or a portion of the entity data record 110, that is stored in memory 142 of requesting device 138. A key 148 provided by the entity record system 102 may allow the requesting device 138 to access requested data 146 that is stored in the entity record 150. The use of a blockchain improves the security of information stored in the entity data record 110, while also facilitating efficient review of how the information (e.g., attributes 114a,b and/or authentication score 116) is changed and used over time (e.g., by reviewing changes to the blockchain over time). Example implementation of a blockchain is described in greater detail with respect to FIG. 2A below. In some cases, the entity data record 110 is a graph database, as illustrated in the example of FIG. 2B, described further below. Use of a graph database facilitates user-friendly review of entity information (e.g., attributes 114a,b and/or authentication scores 116) and allows a range of information types to be linked or associated with each other.

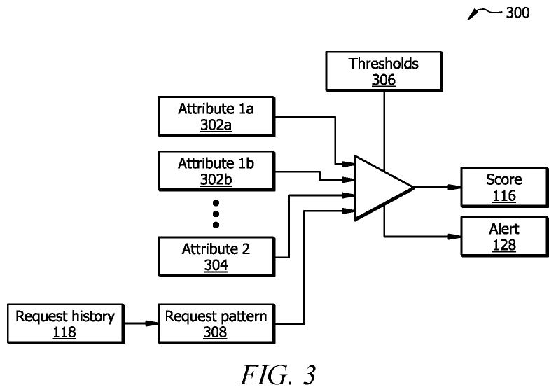

In some embodiments, the entity record system 102 stores (or reviews) a request history 118. The request history 118 generally includes a log or other record of previous data requests 122 from requesting devices. In embodiments in which the entity data record 110 is stored in a blockchain (see FIG. 2A), the request history 118 may be determined by accessing blocks of the blockchain at different previous time points. In some cases, whether or not to allow a request 122 may be determined at least in part using the request history 118. For example, a pattern of previous requests determined from the request history 118 may indicate that a current request 122 is uncommon and therefore may be indicative of some inappropriate activity (see FIG. 3).

For example, if a data request 124 is outside an established pattern determined from the request history 118, then access to information in the entity data record 110 may be denied (e.g., to prevent undesired access to information from the entity data record 110) and/or an updated authentication score 120 may be determined and stored. The updated authentication score 120 may reflect potential inauthentic activities for the entity 112 (e.g., to decrease trust in the information stored about the entity 112). For example, the entity record system 102 may detect a change from an established request pattern associated with the request history 118 (see FIG. 3) that corresponds to an increase in data requests 124 for information associated with a given entity 112 above a threshold level and determine an updated score 120 (e.g., to decrease the authentication score 116 for the entity 112). An alert 128 may also be sent to inform an appropriate party (e.g., an administrator of the entity record system 102) of this request 122. As another example, if a change request 126 is outside an established pattern determined from the request history 118, then an alert 128 may be sent to review the change requests 126.

The entity record system 102 includes a processor 104, a memory 106, and a network interface 108. The processor 104 of the user device 102 includes one or more processors. The processor 104 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 104 may be a programmable logic device, a microcontroller, a microprocessor, or any suitable combination of the preceding. The processor 104 is communicatively coupled to and in signal communication with the memory 106 and network interface 108. The one or more processors are configured to process data and may be implemented in hardware and/or software. For example, the processor 104 may be 8-bit, 16-bit, 32-bit, 64-bit or of any other suitable architecture. The processor 104 may include an arithmetic logic unit (ALU) for performing arithmetic and logic operations, processor registers that supply operands to the ALU and store the results of ALU operations, and a control unit that fetches instructions from memory 106 and executes them by directing the coordinated operations of the ALU, registers and other components.

The memory 106 is operable to store any data, instructions, logic, rules, or code operable to execute the functions of the entity record system 102. The memory 106 may store, for example, the entity data record 110, request history 118, and requests 122. The memory 106 includes one or more disks, tape drives, or solid-state drives, and may be used as an over-flow data storage device, to store programs when such programs are selected for execution, and to store instructions and data that are read during program execution. The memory 106 may be volatile or non-volatile and may comprise read-only memory (ROM), random-access memory (RAM), ternary content-addressable memory (TCAM), dynamic random-access memory (DRAM), and static random-access memory (SRAM).

The network interface 108 is configured to enable wired and/or wireless communications. The network interface 108 is configured to communicate data between the entity record system 102 and other network devices, systems, or domain(s), such as requesting device(s) 138. The network interface 108 is an electronic circuit that is configured to enable communications between devices. For example, the network interface 108 may include one or more serial ports (e.g., USB ports or the like) and/or parallel ports (e.g., any type of multi-pin port) for facilitating this communication. As a further example, the network interface 108 may include a WIFI interface, a local area network (LAN) interface, a wide area network (WAN) interface, a modem, a switch, or a router. The processor 104 is configured to send and receive data using the network interface 108. The network interface 108 may be configured to use any suitable type of communication protocol.

The requesting device 138 is generally any appropriate device for facilitating interaction with information stored in entity data record 110. For example, the requesting device 138 may be a smartphone, a computer, a tablet, or the like. The requesting device 138 includes a processor 140, memory 142, and a network interface 144. The processor 140 includes one or more processors, which may be the same as or similar to the processor(s) of processor 104, described above for the entity record system 102. The processor 140 is communicatively coupled to and in signal communication with the memory 142 and network interface 144.

The memory 142 is operable to store any data, instructions, logic, rules, or code operable to execute the functions of the requesting device 138. The memory 142 may have the same or a similar structure and/or hardware components as described with respect to the memory 106 of the entity record system 102 above. The memory 142 may store a request 122, a received response 156, and entity record 150. The network interface 144 of the requesting device 138 is configured to enable wired and/or wireless communications. The network interface 144 may have the same or a similar structure and/or hardware components as described with respect to the network interface 108 of the entity record system 102 above. The network interface 144 sends request 122 and receives response 156.

### Example Entity Data Record as a Graph Database in a Blockchain

FIG. 2A illustrates an example of the entity data record 110 as a blockchain. A blockchain generally refers to a database shared by a plurality of devices (e.g. devices making up the entity record system 102 and optionally including requesting devices 138) in a network. System 100 may employ any suitable number of devices to form a distributed network that maintains the entity data record 110 in the form of a blockchain, as illustrated in FIG. 2A.

Each blockchain links together blocks 202a-c of data which includes identifiable data entries 204a-c, which represent portions of the attributes 114a,b and/or authentication scores 116 stored in the entity data record 110. Data entries 204a-c may include information, one or more files, and/or any other suitable type of data. In some embodiments, the data 204b-c may be all or a portion of a graph database, as illustrated in the example of FIG. 2B, described below.

Each block 202a-c in the blockchain includes a block identifier 206a-c and information derived from a preceding block 202a-c. For example, every block 202a-c in the blockchain includes a hash 208a-c of the previous block 202a-c. By including the hash 208a-c, the blockchain includes a chain of blocks 202a-c from a genesis block 202a (or a block not shown to the left of block 202a in the example of FIG. 2A) to the latest block 202c (or a block not shown to the right of block 202c in the example of FIG. 2A). Each block 202a-c is guaranteed to come after the previous block 202a-c chronologically (see time axis at bottom of FIG. 2A) because the previous block's hash 208a-c would otherwise not be known. For example, a first block 202a may be created at a first time (or time period) 212, while subsequent second block 202b and third block 202c are created at subsequent second time 214 and third time 216, respectively.

In one embodiment, blocks 202a-c in a blockchain may be linked together by identifying a preceding block 202a-c with a cryptographic checksum (e.g. secure hash algorithm (SHA)-256) of its contents (e.g. the data entry 204a-c and additional metadata) which serves as each block's unique identifier. Links are formed by storing the cryptographic checksum identifier of one block 202a-c in the metadata of another block 202a-c, such that the former block 202a-c becomes the predecessor of the latter block 202a-c. In this way, the blocks 202a-c form a chain that can be navigated from block-to-block by retrieving the cryptographic checksum of a particular block's predecessor from the particular block's own metadata. Each block 202a-c is computationally impractical to modify once it has been in the blockchain because every block 202a-c after it would also have to be regenerated. These features protect data 204a-c (e.g., attributes 114a,b and/or authentication scores 116 of FIG. 1) stored in the blockchain entity data record 110 from being modified by bad actors which provides further information security. When the entity record system 102 stores an entry (e.g. one or more data entries 204a-c in a block 202a-c) in the entity data record 110, the blockchain for all devices in the distributed network is also updated with the new entry 204a-c. Thus, data 204a-c published in a blockchain is available and accessible to every network device with the entity data record 110. This allows the data 204a-c stored in the block 202a-c to be accessible for inspection and verification at any time by any device with a copy of the entity data record 110. In embodiments where requesting devices 138 store all or a portion of the blockchain entity data record 110 (e.g., as entity record 150), the key 148 may be needed for a user to view the data 204a-c (e.g., attributes 114a,b and/or authentication scores 116) in an interpretable format.

In some embodiments, each block 202a-c may include a corresponding key 210a-c. The key 210a-c may be used to encrypt and/or decrypt data entries 204a-c or otherwise control access to data entries 204a-c. For example, a key 210a-c may be used to encrypt data (e.g., such that data 204a-c is encrypted data) stored in a block 202a-c. The key 210a-c may also be used to decrypt and recover the original data 204a-c (e.g., when combined with an access key 148, such that the data 204a-c in the entity data record 110, or entity record 150, can be viewed). The key 210a-c may be any suitable type of encryption/decryption or hashing key.

FIG. 2B illustrates an example in which the data 204a-c in the blockchain entity data record 110 of FIG. 2A is stored as a graph database. In this example, data 204a in the first block 202a is a graph database in which an entity 250 is associated with a number of attributes 252a-d and an authentication score 254. Attributes 252a-d, 256 and entity 250 correspond to attributes 114a,b and entity 112, respectively, of FIG. 1. Data 204b from time 214 has an additional attribute 256 added for entity 250. As such, each entry of data 204a-c of FIG. 2A may be all or portion of a graph database. In some cases, to further improve efficiency and reduce consumption of memory resources, data 204a-c for each time 212, 214, 216 may indicate an offset from the previous entry of data 204a-c. For example, the data 204b for time 214 may indicate that additional attribute 256 is added for entity 250 in the manner shown, such that the full graph database can be reconstructed from the available blocks 202a-c. In some cases, the entity record system 102 may generate and display a visual representation of changes made to the entity data record 110 over time as indicated by the request history 118. FIG. 2B also illustrates an example of such a visual representation 260 in the example form of changes from time 212 to time 214. The visual representation 260 may be all or a portion of a view of a graph database.

### Example Operation of the Data Profile and Security System

FIG. 3 is a flow diagram 300 illustrating an example determination of an authentication score 116 and/or alert 128. The authentication score 116 may be determined by comparing two or more attributes 302a,b, 304 to each other and/or to a threshold value 306. Attributes 302a,b, 304 correspond to attributes 114a,b of FIG. 1. For example, attributes 302a,b for the same property (e.g., a name) may be compared to each other. For example, attribute 302a indicating an entity name may be compared to attribute 302b indicating another name for the same entity. If these names match, the authentication score 116 may have an increased value. If the names do not match, the authentication score 116 may be decreased. A threshold name value 306 (e.g., a known correct name) may be established for the entity 112, and the name attributes 302a,b may be compared to the threshold name value 306 name. A match leads to an increased authentication score 116. Other examples of threshold values 306 include known locations or addresses associated with the entity 112, dates (e.g., date of birth of individual, date of registration of an organization, etc.) associated with the entity 112, and the like. Multiple attributes 302a,b may be compared to each other and/or a threshold value 306 simultaneously. In some cases, a single attribute 304 may be compared to a threshold value 306 individually to determine or adjust the authentication score 116. If the authentication score 116 is less than a threshold value 306, an alert 128 may be sent to an interested party.

FIG. 3 also illustrates adjusting an authentication score 116 and/or sending an alert 128 based on a request pattern 308 determined from the request history 118. The request pattern 308 may indicate a common range of frequencies at which data requests 124 and/or change requests 126 are received for a given entity 112 (e.g., a number of requests 124, 126 per week, month, or the like). Similarly, an updated authentication score 116 may be determined to reflect the change from the request pattern 308 (e.g., to decrease the score 116 in response to an uncommon usage of the data in the entity data record 110). The updated authentication score 120 may reflect potential inauthentic activities for the entity 112 (e.g., to decrease trust in the information stored about the entity 112). For example, the entity record system 102 may detect a change from an established request pattern 308 associated with the request history 118 that corresponds to an increase in data requests 124 for information associated with a given entity 112 above a threshold level 306 and determine an updated score 120 (see FIG. 1). An alert 128 may also be sent to inform an appropriate party (e.g., an administrator of the entity record system 102) of this request 122. As another example, if a change request 126 is outside an established request pattern 308 determined from the request history 118, then an alert 128 may be sent to review the change requests 126.

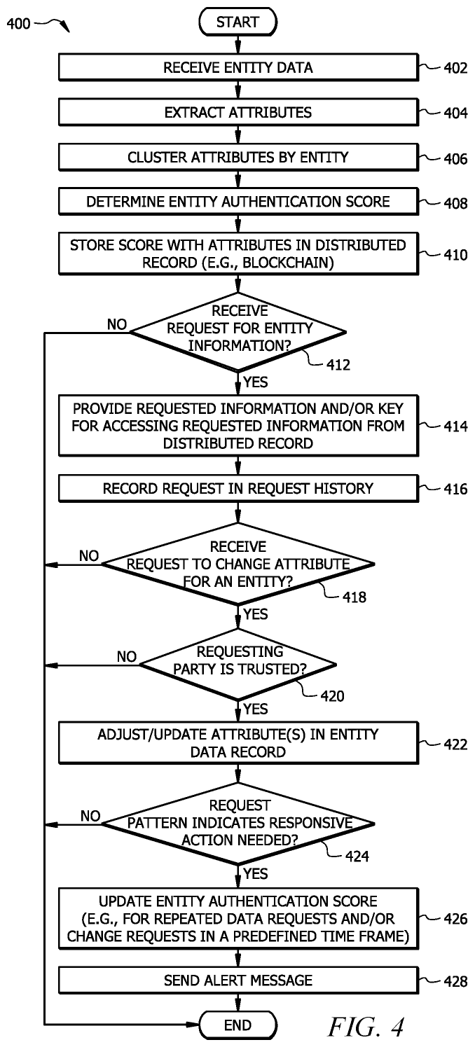

FIG. 4 illustrates an example method 400 of operating the data profile and security system 100 of FIG. 1. Method 400 may be implemented by the processor 104, memory 106, and network interface 108 of the entity record system 102. The method 400 may begin at step 402 where entity data 134a,b is received from data sources 132a,b. At step 404 attributes 114a,c are extracted from the entity data 134a,b. For example, certain attributes 114a,b may be extracted from entries of a spreadsheet. In some cases, natural language processing may be used to detect attributes 114a,b within entity data 134a,b, such as documents.

At step 406, the attributes 114a,b are clustered by entity 112, as illustrated in FIG. 1 and FIG. 2B. For example, each entity 112 may be associated or linked with data entries corresponding to the entity's attributes 114a,b. FIG. 2B illustrates this clustering in the form of a graph database.

At step 408, an authentication score 116 may be determined for each entity 112. Determination of authentication score 116 is described in greater detail above with respect to FIGS. 1 and 3. At step 410, the authentication scores 116 are stored in the entity data record 110.

At step 412, the entity record system 102 determines if a data request 124 is received. If a data request 124 is received, the entity record system 102 proceeds to step 414. At step 414, the requested information is provided, for example, as response 156 of FIG. 1. The response 156 may include requested data 146 and/or a key 148 for accessing requested data 146. At step 416, the received data request 124 may be stored in the request history 118.

At step 418, the entity record system 102 determines if a change request 126 is received. If a change request 126 is received, the entity record system 102 proceeds to step 420 and determine whether the requesting party is trusted. If the requesting party is trusted, the entity record system 102 proceeds to step 422 and makes the attribute change 130 (see FIG. 1 and corresponding description above). Otherwise, the attribute change 130 may be prevented and/or an alert 128 of the attempted change 126 may be sent.

At step 424, the entity record system 102 determines if a request pattern 308 indicates that some corrective action or review is needed (e.g., to adjust the authentication score 116 and/or send an alert 128 as described above with respect to FIGS. 1 and 3). At step 426, the authentication score 116 for an entity 112 may be adjusted. For example the authentication score 116 may be decreased if the request pattern 308 indicates frequently repeated requests for information about the entity 112. At step 428, an alert 128 may be sent indicating the change to the authentication score 116 and/or requesting review of information about the entity 112 or the requests 122 sent in relation to this entity 112.

While several embodiments have been provided in this disclosure, it should be understood that the disclosed system and method might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A system, comprising:
a first device comprising:
a first memory operable to store an entity data record comprising, for each of a plurality of entities, a plurality of attribute data entries, each attribute data entry indicating a characteristic of the entity; and
a first processor communicatively coupled to the first memory and configured to:
determine, for each entity of the plurality of entities, an authentication score indicating an extent to which the characteristics indicated by the attribute data entries for the entity are authenticated; and
store the authentication score in the memory for each entity in the entity data record; and
a second device comprising a second processor configured to provide a request for information about a first entity of the plurality of entities;
wherein the first processor of the first device is further configured to:
receive the request for information about the first entity of the plurality of entities; and
after receiving the request, provide one or more attribute entries associated with the first entity and a first authentication score of the first entity to the second device.

2. The system of claim 1, wherein the first processor is further configured to receive entity data from at least a first data source and a second data source, wherein the received entity data comprises a first attribute from the first data source and a second attribute from the second data source, wherein the first attribute and second attribute are in a different format.

3. The system of claim 1, wherein the first memory is further configured to store the entity data record in a blockchain.

4. The system of claim 3, wherein the entity data record is stored in the blockchain as a graph database.

5. The system of claim 1, wherein the first memory is further configured to store a request history record comprising a log of one or both of previously requested changes to attributes of a first entity and previous requests for information about the first entity.

6. The system of claim 5, wherein the first processor is further configured to generate and display a visual representation of changes made to the entity data record over time as indicated by the request history record.

7. The system of claim 5, wherein the first processor is further configured to:
detect a change from an established request pattern associated with the request history record, wherein the change corresponds to an increase in requests for information associated with the first entity above a threshold value; and
after detecting the change, adjust the first authentication score for the first entity.

8. The system of claim 5, wherein the first processor is further configured to:
detect a change from an established request pattern associated with the request history record, wherein the change corresponds to a change to an attribute value of the first entity; and
after detecting the change, send an alert message requesting review of the change to the attribute value of the first entity.

9. The system of claim 1, wherein the first processor is further configured to determine the authentication score for each entity by comparing two or more attribute properties to each other or to a threshold value.

10. A method, comprising:
storing an entity data record comprising, for each of a plurality of entities, a plurality of attribute data entries, each attribute data entry indicating a characteristic of the entity;
determining, for each entity of the plurality of entities, an authentication score indicating an extent to which the characteristics indicated by the attribute data entries for the entity are authenticated;
storing the authentication score for each entity in the entity data record;
receiving a request for information about a first entity of the plurality of entities; and
after receiving the request, provide one or more attribute entries associated with the first entity and a first authentication score of the first entity to a requesting device.

11. The method of claim 10, further comprising receiving entity data from at least a first data source and a second data source, wherein the received entity data comprises a first attribute from the first data source and a second attribute from the second data source, wherein the first attribute and second attribute are in a different format.

12. The method of claim 10, further comprising storing the entity data record as a graph database in a blockchain.

13. The method of claim 10, further comprising:
storing a request history record comprising a log of one or both of previously requested changes to attributes of a first entity and previous requests for information about the first entity;
generating and displaying a visual representation of changes made to the entity data record over time as indicated by the request history record;
detecting a change from an established request pattern associated with the request history record, wherein the change corresponds to an increase in requests for information associated with the first entity above a threshold value; and
after detecting the change, adjusting the first authentication score for the first entity.

14. A device, comprising:
a memory operable to store an entity data record comprising, for each of a plurality of entities, a plurality of attribute data entries, each attribute data entry indicating a characteristic of the entity; and
a processor communicatively coupled to the memory and configured to:
determine, for each entity of the plurality of entities, an authentication score indicating an extent to which the characteristics indicated by the attribute data entries for the entity are authenticated;
cause the memory to store the authentication score for each entity in the entity data record;
receive a request for information about a first entity of the plurality of entities; and
after receiving the request, provide one or more attribute entries associated with the first entity and a first authentication score of the first entity to a requesting device.

15. The device of claim 14, wherein the processor is further configured to receive entity data from at least a first data source and a second data source, wherein the received entity data comprises a first attribute from the first data source and a second attribute from the second data source, wherein the first attribute and second attribute are in a different format.

16. The device of claim 14, wherein the memory is further configured to store the entity data record as a graph database in a blockchain.

17. The device of claim 14, wherein the memory is further configured to store a request history record comprising a log of one or both of previously requested changes to attributes of a first entity and previous requests for information about the first entity.

18. The device of claim 17, wherein the processor is further configured to generate and display a visual representation of changes made to the entity data record over time as indicated by the request history record.

19. The device of claim 17, wherein the processor is further configured to:
detect a change from an established request pattern associated with the request history record, wherein the change corresponds to an increase in requests for information associated with the first entity above a threshold value; and
after detecting the change, adjust the first authentication score for the first entity.

20. The device of claim 17, wherein the processor is further configured to:
detect a change from an established request pattern associated with the request history record, wherein the change corresponds to a change to an attribute value of the first entity; and
after detecting the change, send an alert message requesting review of the change to the attribute value of the first entity.
